(19) United States
(12) Patent Application Publication
(10) Pub. No.: US 2015/0295440 A1
(43) Pub. Date: Oct. 15, 2015

(54) MOBILE POWER SUPPLY DEVICE

(71) Applicant: C-TECH UNITED CORP., New Taipei City (TW)

(72) Inventor: Chen Yen LIAO, New Taipei City (TW)

(73) Assignee: C-TECH UNITED CORP., New Taipei City (TW)

(21) Appl. No.: 14/253,477

(22) Filed: Apr. 15, 2014

(51) Int. Cl. H02J 7/00

(52) U.S. Cl. CPC H02J 7/0045; H02J 7/0027; H02J 7/0054; H02J 7/007

(57) ABSTRACT

A mobile power supply device includes a casing having a locating groove extending around the periphery thereof, a battery set and a control unit mounted in the casing and electrically coupled together, a first transmission arm fastened with one end thereof to the casing and receivable in the locating groove and having a first electrical connection terminal located at a distal end thereof electrically connected to the control unit for power output, a first extension arm extended from a middle part thereof and a second electrical connection terminal located at the distal end of the first extension arm and electrically connected to the control unit for power output, and a second transmission arm fastened with one end thereof and receivable in the locating groove of the casing and having a third electrical connection terminal located at a distal end thereof and electrically connected to the control unit for power output.

### BACKGROUND OF THE INVENTION

1. Field of the Invention

The present invention relates to power supply technology and more particularly, to a mobile power supply device that provides multiple electrical connection terminals for charging multiple mobile electronic devices at a time.

2. Description of the Related Art

With the advancement of digital electronic communication devices and networks, we can see people operating smart phones, tablet PCs and other mobile electronic devices anywhere and anytime. These mobile electronic devices have become very popular over the years, and are widely used by people as requisite personal equipment. As these portable electronic devices can help people deal with a lot of daily affairs or information inquiries, and can also be used as a multimedia device for social communication and entertainment purposes, their importance in our daily life is undoubtable.

With functional integration, sophisticated mobile electronic devices are continuously created. In order to enhance portability, these sophisticated mobile electronic devices are small-sized, however, they have the problem of high power consumption.

People normally will use a power cable to connect a mobile electronic device to a city power supply outlet for enabling the battery of the mobile electronic device to be charged. A mobile power supply device can also be used to charge mobile electronic devices anywhere and anytime. Many high capacity mobile power supply devices are commercially available. However, these commercial mobile power supply devices commonly have only one electrical connection terminal for power output, i.e., these commercial mobile power supply devices can only charge one particular mobile electronic device at a time.

### SUMMARY OF THE INVENTION

The present invention has been accomplished under the circumstances in view. It is the main object of the present invention to provide a mobile power supply device, which comprises a plurality of electrical connection terminals respectively electrically connectable to different mobile electronic devices for charging multiple mobile electronic devices at a time.

To achieve this and other objects of the present invention, a mobile power supply device of the invention comprises a casing, a battery set, a control unit, a first transmission arm, and a second transmission arm. The casing comprises an accommodation chamber defined therein and a locating groove extending around the periphery thereof. The battery set is mounted in the accommodation chamber of the casing. The control unit is mounted in the accommodation chamber of the casing and electrically coupled with the battery set. The first transmission arm is receivable in the locating groove of the casing at one side relative to the casing, comprising a first end fastened to the casing and defining with the locating groove a first receiving chamber, a second end opposite to the first end, a first electrical connection terminal located at the second end and electrically connected to the control unit for charging an external mobile electronic device, a first extension arm extended from a middle part thereof, and a second electrical connection terminal located at a distal end of the first extension arm and electrically connected to the control unit for charging an external mobile electronic device. The second transmission arm is receivable in the locating groove of the casing at an opposite side relative to the casing, comprising a first end fastened to the casing and defining with the locating groove a second receiving chamber for receiving the first electrical connection terminal, a second end opposite to the first end, and a third electrical connection terminal located at the second end and electrically connected to the control unit for charging an external mobile electronic device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a mobile power supply device in accordance with the present invention.

FIG. 2 corresponds to FIG. 1 when viewed from another angle.

FIG. 3 is a perspective assembly view of the mobile power supply device in accordance with the present invention.

FIG. 4 is a schematic applied view of the mobile power supply device in accordance with the present invention (I).

FIG. 5 is a schematic applied view of the mobile power supply device in accordance with the present invention (II).

FIG. 6 is a schematic applied view of the mobile power supply device in accordance with the present invention (III).

FIG. 7 is a schematic applied view of the mobile power supply device in accordance with the present invention (IV).

### DETAILED DESCRIPTION OF THE PREFERRED EMBODIMENT

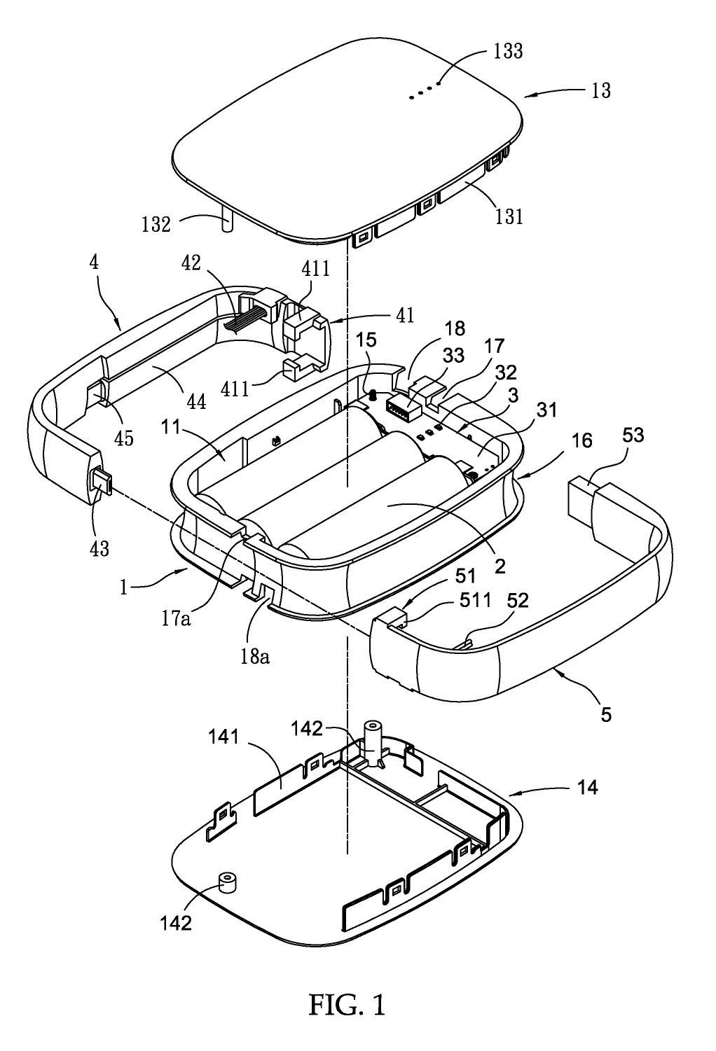

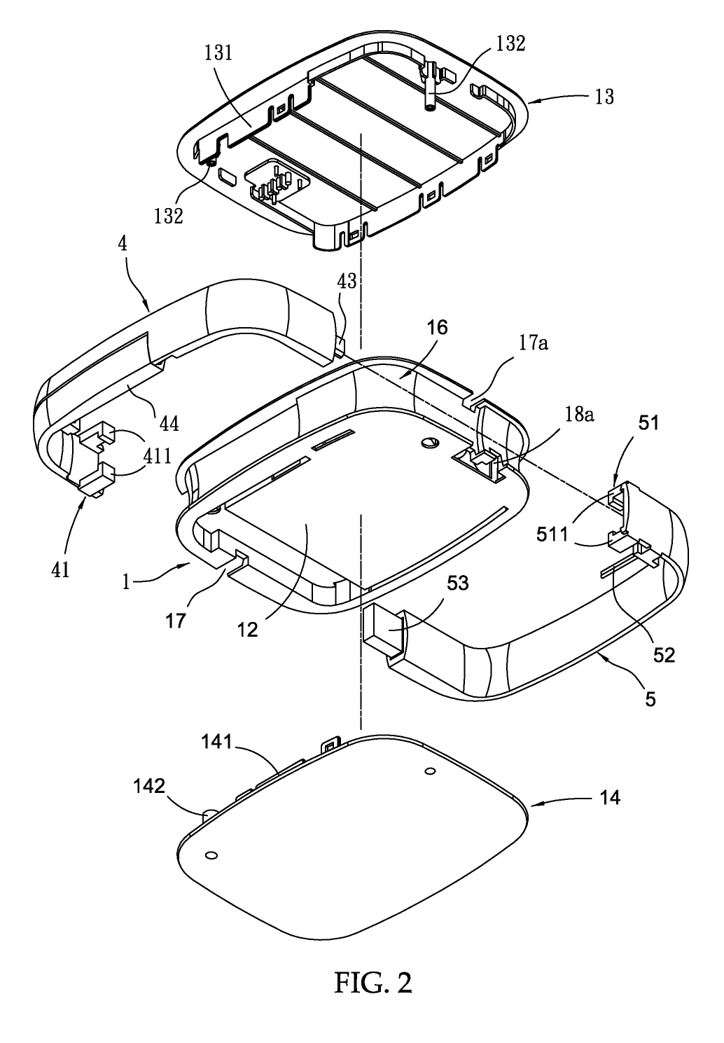

Referring to FIGS. 1 and 2, a mobile power supply device in accordance with the present invention is shown. The mobile power supply device comprises a casing 1, a top cover 13, a bottom cover 14, a battery set 2, a control unit 3, a first transmission arm 4, and a second transmission arm 5.

The casing 1 comprises an accommodation chamber 11, a partition plate 12 transversely disposed in the accommodation chamber 11, a locating groove 16 extending around the periphery thereof, two connection holes 17 and 17a located in the periphery thereof at two opposite sides, and two insertion holes 18 and 18a located in the periphery thereof and respectively disposed adjacent to the connection holes 17 and 17a. The top cover 13 and the bottom cover 14 are respectively attached to opposing top and bottom sides of the casing 1. The top cover 13 comprises a plurality of mounting flanges 131 respectively downwardly extended from the border area thereof and respectively downwardly inserted into the top side of the casing 1 and abutted against the inside wall of the casing 1, a plurality of connection columns 132 downwardly extended from a bottom wall thereof at selected locations, and a plurality of lamp holes 133 cut through the opposing top and bottom walls thereof. The bottom 14 comprises a plurality of mounting flanges 141 respectively upwardly inserted into the bottom side of the casing 1 and abutted against the inside wall of the casing 1, and a plurality of connection columns 142 upwardly extended from a top wall thereof and respectively fixedly fastened to the connection columns 132 of the top cover 13 by respective screws 15.

The battery set 2 is mounted in the accommodation chamber 11 of the casing 1 and supported on the partition plate 12. In this embodiment, the battery set 2 consists of a plurality of battery cells electrically connected in series.

The control unit 3 is mounted in the accommodation chamber 11 of the casing 1 and electrically coupled with the battery set 2 for controlling charging and discharging operations of the battery set 2. Further, the control unit 3 comprises a circuit board 31 fixedly supported on the partition plate 12, a plurality of indicator lights 32 installed in the circuit board 31 and respectively facing toward the lamp holes 133 and respectively controllable by the circuit board 31 to give off light through the lamp holes 133, and an electrical connector 33 electrically connected to the circuit board 31.

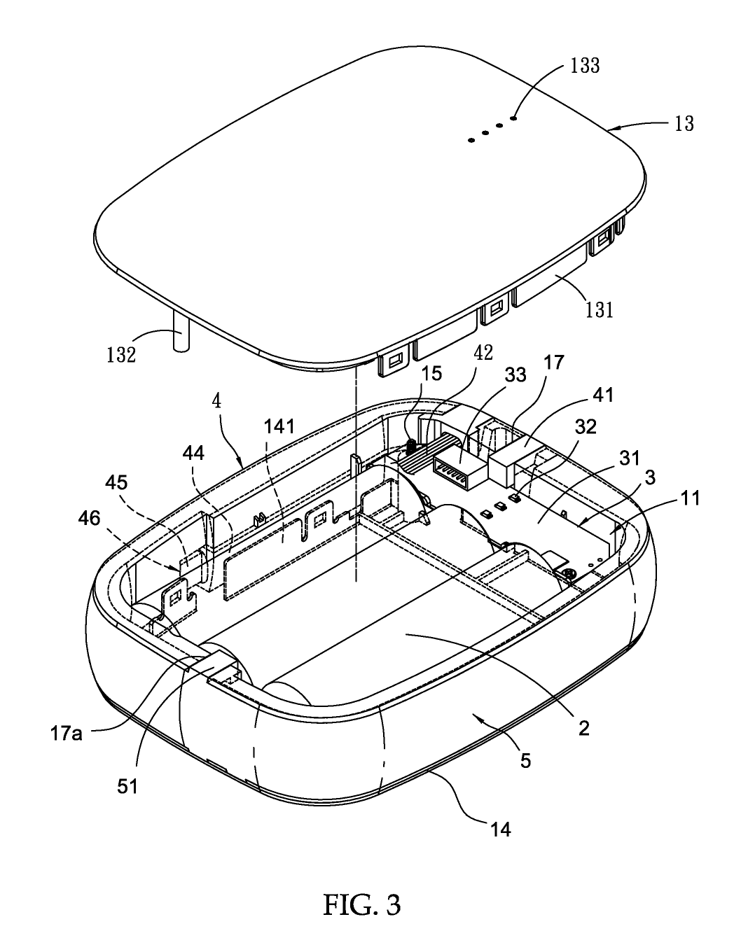

The first transmission arm 4 and the second transmission arm 5 are elastically deformable members respectively connected to the connection holes 17 and 17a of the casing 1 and received in the locating groove 16 of the casing 1. The first transmission arm 4 comprises a mounting frame 41 located at one end thereof and providing a plurality of hook rods 411 for hooking in one connection hole 17 of the casing 1 to secure the first transmission arm 4 to the casing 1, a set of lead wires 42 inserted through one insertion hole 18 of the casing 1 and electrically connected to the control unit 3 and the battery set 2 for the transmission of the battery power supply of the battery set 2, a first electrical connection terminal 43, for example, but not limited to, Micro USB connector, located at an opposite end thereof remote from the mounting frame 41 and electrically coupled with the set of lead wires 42 for power transmission, an elastically deformable first extension arm 44 extended from a middle part thereof, a second electrical connection terminal 45, for example, but not limited to, lightning connector, located at a distal end of the first extension arm 44 and electrically coupled with the set of lead wires 42 for communication with the control unit 3, and an opening 46, as shown in FIG. 3, for accommodating the second electrical connection terminal 45 to keep the second electrical connection terminal 45 from sight when it is not used.

The second transmission arm 5 comprises a mounting frame 51 located at one end thereof and providing a plurality of hook rods 511 for hooking in the other connection hole 17a of the casing 1 to secure the second transmission arm 5 to the casing 1, a set of lead wires 52 inserted through the other insertion hole 18a of the casing 1 and electrically connected to the control unit 3 and the battery set 2 for the transmission of the battery power supply of the battery set 2, a third electrical connection terminal 53, for example, but not limited to, USB connector, located at an opposite end thereof remote from the mounting frame 51 and electrically coupled with the set of lead wires 52 for power transmission.

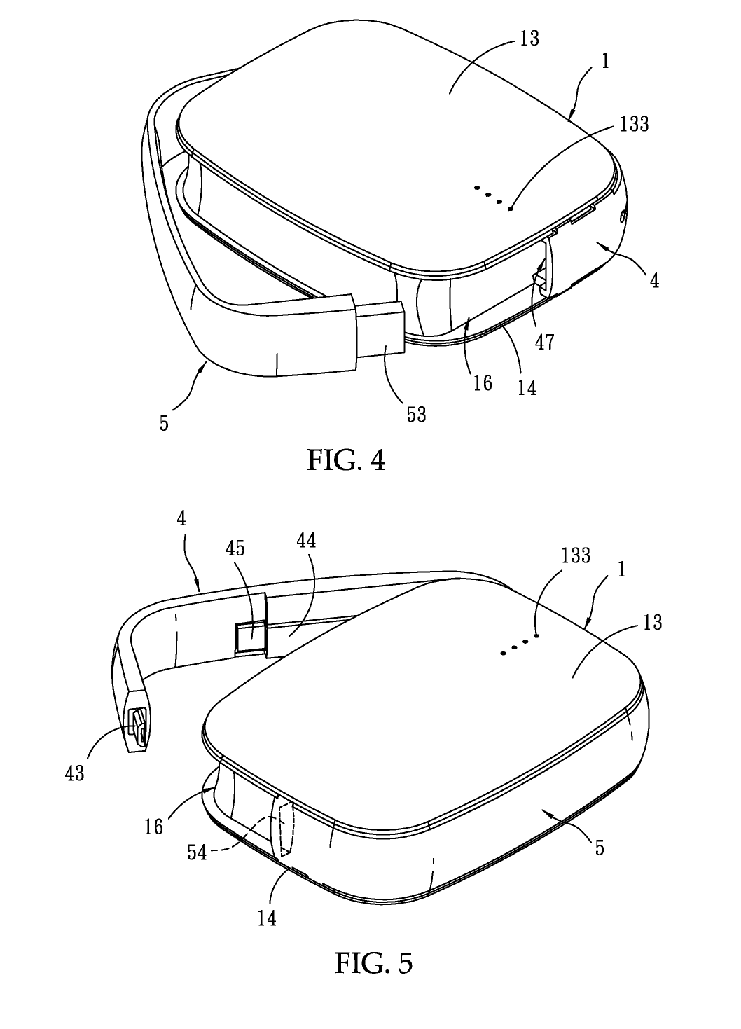

Referring to FIGS. 4 and 5, after fastened the mounting frames 41 and 51 of the first transmission arm 4 and second transmission arm 5 to the connection holes 17 and 17a of the casing 1, the first transmission arm 4 and the second transmission arm 5 are received in the locating groove 16 of the casing 1 and respectively define with the locating groove 16 a first receiving chamber 47 and a second receiving chamber 54 for receiving the third electrical connection terminal 53 and the first electrical connection terminal 43 respectively.

Referring to FIGS. 4 and 5, when the mobile power supply device is not used, the first transmission arm 4 and the second transmission arm 5 are received in the locating groove 16; the first electrical connection terminal 43 and the third electrical connection terminal 53 are respectively received in the second receiving chamber 54 and the first receiving chamber 47.

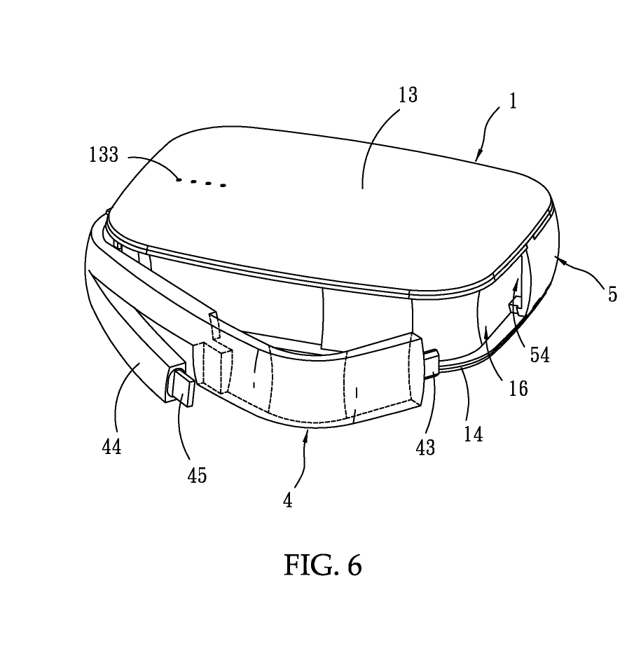

Referring to FIG. 6, the first transmission arm 4 and the second transmission arm 5 can be selectively used for charging different mobile electronic devices. For example, when using the first transmission arm 4, remove the first electrical connection terminal 43 of the first transmission arm 4 from the second receiving chamber 54. Subject to the flexible material property of the first transmission arm 4, the first transmission arm 4 can be adjusted to the desired charging angle. When wishing to use the second electrical connection terminal 45 of the first transmission arm 4, adjust the first extension arm 44 to remove the second electrical connection terminal 45 from the opening 46 for application. Thus, different electrical connection terminals can be selectively used for charging different mobile electronic devices.

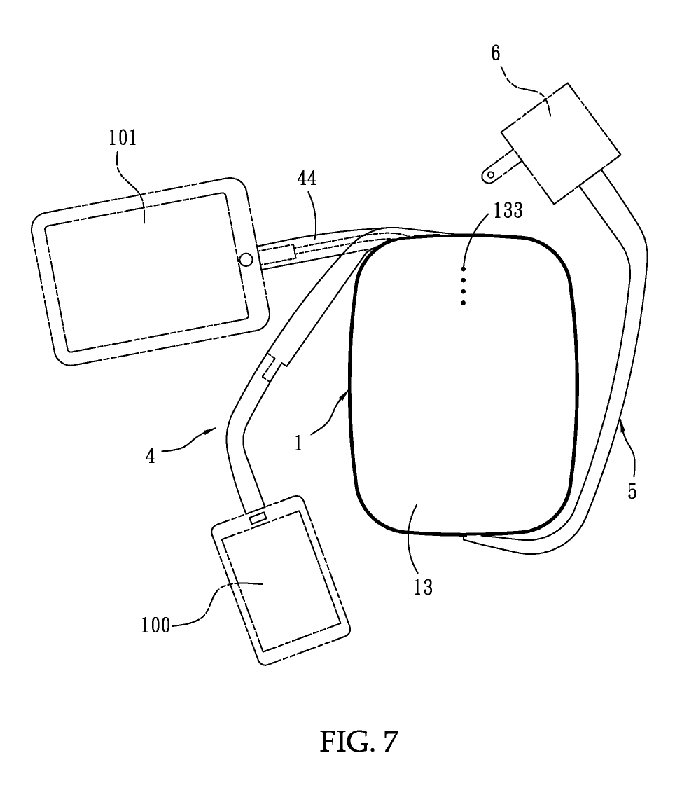

Referring to FIG. 7 and FIG. 1 again, the third electrical connection terminal 53 of the second transmission arm 5 can be connected to an electrical plug 6 that is connectable to an external power source for enabling the external power source to be transmitted through the second transmission arm 5 to charge the battery set 2. Further, the mobile power supply device can also be used as a charging device to transmit electricity from an external power source to the first electrical connection terminal 43 and second electrical connection terminal 45 of the first transmission arm 4 for charging different mobile electronic devices 100 and 101.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mobile power supply device, comprising:
a casing comprising an accommodation chamber defined therein and a locating groove extending around the periphery thereof;
a battery set mounted in said accommodation chamber of said casing;
a control unit mounted in said accommodation chamber of said casing and electrically coupled with said battery set;
a first transmission arm receivable in said locating groove of said casing at one side relative to said casing, said first transmission arm comprising a first end fastened to said casing and defining with said locating groove a first receiving chamber, a second end opposite to the first end of said first transmission arm, a first electrical connection terminal located at the second end of said first arm and electrically connected to said control unit for charging an external mobile electronic device, a first extension arm extended from a middle part thereof, and a second electrical connection terminal located at a distal end of said first extension arm and electrically connected to said control unit for charging an external mobile electronic device; and
a second transmission arm receivable in said locating groove of said casing at an opposite side relative to said casing, said second transmission arm comprising a first end fastened to said casing and defining with said locating groove a second receiving chamber for receiving said first electrical connection terminal, a second end opposite to the first end of said second transmission arm, a third electrical connection terminal located at the second end of said second arm and electrically connected to said control unit for charging an external mobile electronic device.

2. The mobile power supply device as claimed in claim 1, further comprising a top cover and a bottom cover respectively fastened to opposing top and bottom sides of said casing.

3. The mobile power supply device as claimed in claim 2, wherein said top cover comprises a plurality of mounting flanges respectively downwardly extended from the border area thereof and respectively downwardly inserted into said casing; said bottom cover comprises a plurality of mounting flanges respectively upwardly extended from the border area thereof and respectively upwardly inserted into said casing.

4. The mobile power supply device as claimed in claim 2, wherein said top cover comprises a plurality of downwardly extending connection columns; said bottom cover comprises a plurality of upwardly extending connection columns respectively fastened to the downwardly extending connection columns of said top cover with respective screws.

5. The mobile power supply device as claimed in claim 1, wherein said top cover comprises a plurality of lamp holes; said control unit comprises a circuit board, and a plurality of indicator lights mounted at said circuit board and respectively facing toward said lamp holes and controllable to give a respective visual indication signal.

6. The mobile power supply device as claimed in claim 1, wherein said casing comprises two connection holes respectively located in the periphery thereof at two opposite sides for the connection of the respective first ends of said first transmission arm and said first second transmission arm, and two insertion holes respectively disposed adjacent to said connection holes.

7. The mobile power supply device as claimed in claim 6, wherein said first transmission arm and said second transmission arm each comprise a mounting frame located at the respective first end thereof and respectively fastened to said connection holes of said casing.

8. The mobile power supply device as claimed in claim 7, wherein the mounting frames of said first transmission arm and said second transmission arm each comprise a plurality of hook rods respectively hooked in said connection holes of said casing.

9. The mobile power supply device as claimed in claim 6, wherein said first transmission arm and said second transmission arm each comprise a set of lead wires respectively electrically connected with said first electrical connection terminal and said second electrical connection terminal of said first transmission arm and said third electrical connection terminal of said second transmission arm and respectively inserted through said insertion holes of said casing and electrically connected to said control unit.

10. The mobile power supply device as claimed in claim 1, wherein said battery set comprises a plurality of battery cells electrically connected in series.

11. The mobile power supply device as claimed in claim 1, wherein said first transmission arm and said second transmission arm are elastically deformable.

12. The mobile power supply device as claimed in claim 1, wherein said first electrical connection terminal is a Micro USB connector.

13. The mobile power supply device as claimed in claim 1, wherein said second electrical connection terminal is a lightning connector.

14. The mobile power supply device as claimed in claim 1, wherein said third electrical connection terminal is a USB connector.
